(19) United States
(12) Patent Application Publication
(10) Pub. No.: US 2004/0033829 A1
(43) Pub. Date: Feb. 19, 2004

(54) Symbol matching gaming machine

(76) Inventors: Larry J. Pacey, Prospect Heights, IL (US); William R. Wadleigh, Naperville, IL (US)

Correspondence Address: Michael J. Blankstein, WMS Gaming Inc., 800 South Northpoint Boulevard, Waukegan, IL, 60085, US

(21) Appl. No.: 10/223,519

(22) Filed: Aug. 19, 2002

(51) Int. Cl. G06F 17/00

(52) U.S. Cl. 463/20

(57) ABSTRACT

A symbol matching gaming machine and method of conducting a wagering game on the gaming machine are disclosed. The machine receives a wager from a player and portrays an array of symbols at respective positions in the array. The machine indicates to the player any pairs of symbols in the array that may be swapped to create a predefined, award-generating symbol combination. In response to receiving a selection from the player of one of the any pairs of symbols to swap, the machine swaps the selected pair of symbols and provides an award associated with the symbol combination. The player may continue to select pairs of symbols to swap and earn awards until a predefined, award-generating symbol combination can no longer be created by swapping symbols.

### FIELD OF THE INVENTION

The present invention relates generally to gaming machines and, more particularly, to a symbol matching gaming machine and method.

### BACKGROUND OF THE INVENTION

Video gaming machines, such as video slots, video poker, and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines. Shrewd operators consequently strive to employ the most entertaining and exciting machines available because such machines attract frequent play and hence increase profitability to the operator.

Video gaming machines are typically operable to play such traditional games as slots, poker, bingo, keno, and blackjack. Such games have been enhanced in recent years to include first and second screen bonus features. Due to the proliferation of such bonus features and the repeated use of similar (or even identical) bonus features in different games, many of the enhanced games now appear to be ordinary and mundane. Accordingly, in the competitive gaming machine industry, there is a continuing need for gaming machine manufacturers to produce new types of games, or enhancements to existing games, which will attract frequent play by enhancing the entertainment value and excitement associated with the game.

### SUMMARY OF THE INVENTION

These and other objects are realized by a symbol matching gaming machine and method of conducting a wagering game on the gaming machine. The machine receives a wager from a player and portrays an array of symbols at respective positions in the array. The machine indicates to the player any pairs of symbols in the array that may be swapped to create a predefined, award-generating symbol combination. In response to receiving a selection from the player of one of the any pairs of symbols to swap, the machine swaps the selected pair of symbols and provides an award associated with the symbol combination. The player may continue to select pairs of symbols to swap and earn awards until a predefined, award-generating symbol combination can no longer be created by swapping symbols.

### BRIEF DESCRIPTION OF THE DRAWINGS

The foregoing and other advantages of the invention will become apparent upon reading the following detailed description and upon reference to the drawings.

FIG. 1 is an isometric view of a symbol matching gaming machine embodying the present invention.

FIG. 2 is a block diagram of a control system suitable for operating the gaming machine.

FIGS. 3 through 12 are display screen images associated with a first embodiment of the present invention.

FIGS. 13 through 20 are display screen images associated with a second embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

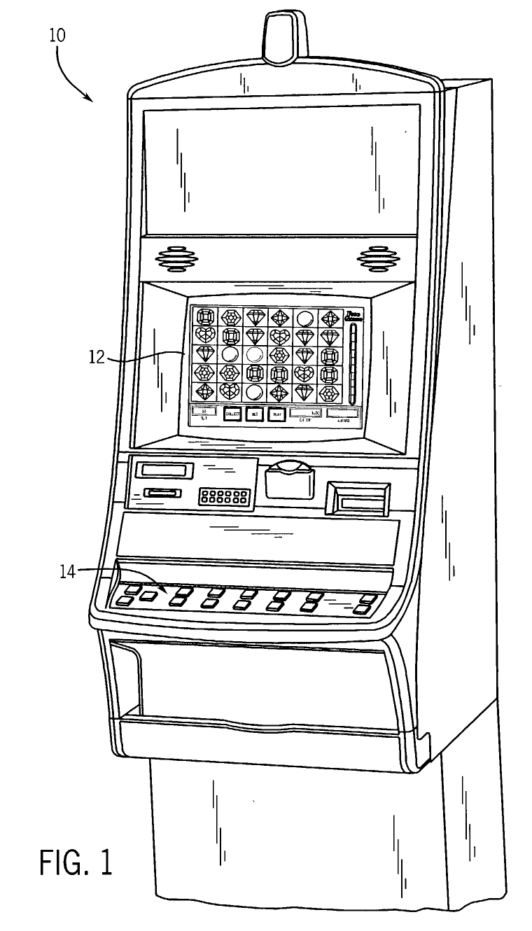

Turning now to the drawings and referring initially to FIG. 1, a symbol matching gaming machine 10 is operable to conduct a wagering game based on a jewel theme. The gaming machine 10 includes a visual display 12 preferably in the form of a dot matrix, CRT, LED, LCD, electro-luminescent, or other type of video display known in the art. The display 12 preferably includes a touch screen overlaying the monitor. In the illustrated embodiment, the gaming machine 10 is an “upright” version in which the display 12 is oriented vertically relative to the player. Alternatively, the gaming machine may be a “slant-top” version in which the display 12 is slanted at about a thirty-degree angle toward the player of the gaming machine 10.

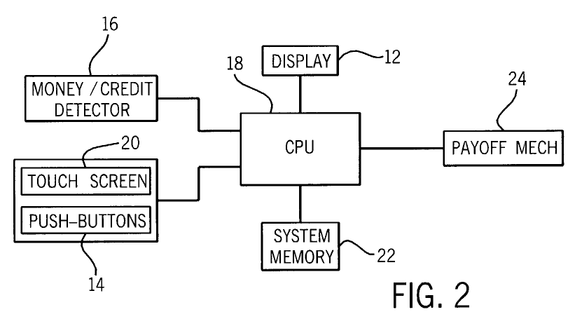

FIG. 2 is a block diagram of a control system suitable for operating the gaming machine 10. Money/credit detector 16 signals a central processing unit (“CPU”) 18 when a player has inserted money or placed a wager. The money may be provided by coins, bills, tickets, coupons, cards, etc. The CPU 18 executes a game program that prompts the player to place a wager and, in response to the wager, causes the video display 12 to portray an array of randomly selected symbols at respective positions in the array. If the array includes a predefined, winning combination of symbols, the CPU 18 provides an award associated with that combination, removes the symbol combination from the array, shifts/cascades symbols that were above the symbol combination downward to fill the positions vacated by the symbols in the symbol combination, and places new randomly selected symbols in any remaining empty positions in the array. The CPU 18 repeats this process until no more winning combinations of symbols are formed by the array.

A system memory 22 stores control software, operational instructions and data associated with the gaming machine 10. In one embodiment, the system memory 22 comprises a separate read-only memory (ROM) and battery-backed random-access memory (RAM). However, it will be appreciated that the system memory 22 may be implemented on any of several alternative types of memory structures or may be implemented on a single memory structure. A payoff mechanism 24 is operable in response to instructions from the CPU 18 to provide an award to the player in response to any winning outcomes. The award may, for example, be in the form of a number of credits. The number of credits is determined by one or more pay tables stored in the system memory 22.

The gaming machine includes a user interface comprising a plurality of pushbuttons 14 (see also FIG. 1), a touch screen 20, and other possible devices. The plurality of push-buttons 14 may, for example, include a “bet” button for wagering, a “play” button for commencing play, a “collect” button for cashing out, a “help” button for viewing a help screen, a “pay table” button for viewing the pay table(s), and a “call attendant” button for calling an attendant. The touch screen 20 may define touch keys for implementing many of these same functions. Other possible user interface devices include a keyboard and a pointing device such as a mouse or trackball.

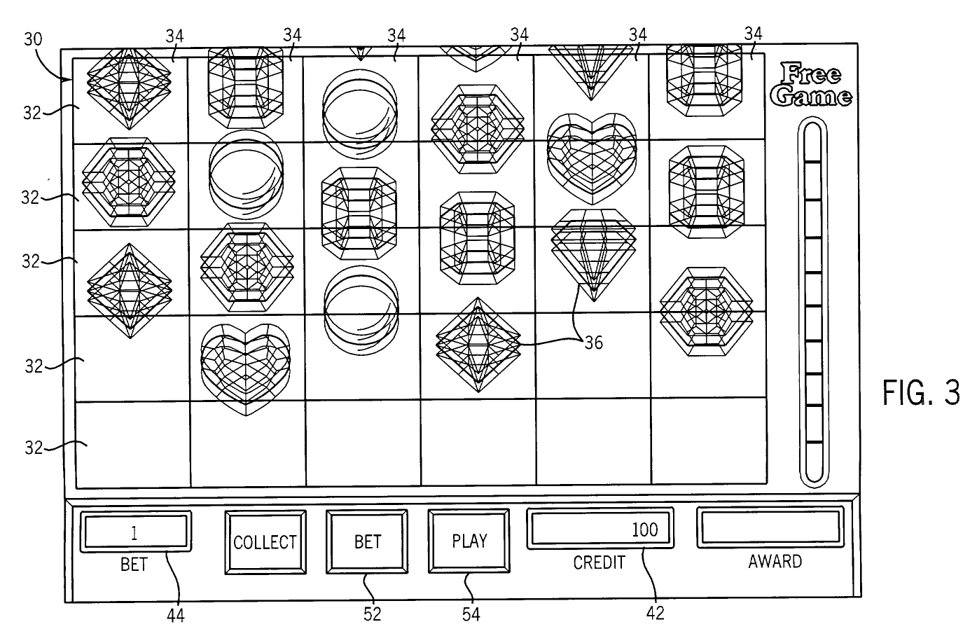

FIGS. 3 through 12 are display screen images associated with a first embodiment of the present invention. Referring to FIG. 3, the display initially portrays an empty array 30 including a plurality of rows 32 and a plurality of columns 34. The number of rows and the number of columns may vary from what is illustrated.

To begin play, a player inserts money into the gaming machine. The amount of inserted money is shown as a corresponding number of credits on a credit meter 42. Next, to initiate a play cycle, the player places a wager by pressing an onscreen “Bet” key 52 a number of times corresponding to the desired number of wagered credits. The minimum wager may, for example, be ten credits and be achieved by pressing the “Bet” key 52 once, while the maximum wager may, for example, be 100 credits and be achieved by pressing the “Bet” key ten times. The display may optionally include a “Max Bet” key (not shown) to allow a player to quickly place the maximum wager. The number of wagered credits is shown on a bet meter 44.

After placing a wager, the player presses an onscreen “Play” key 54 to cause symbols 36 to drop into the empty array 30 from the top of the display. The symbols 36 may, for example, include gems as illustrated, traditional slot symbols such as fruits, sevens, and bars, or other thematic symbols. The machine randomly selects the dropped symbols 36 using a random number generator (RNG). The machine may use reel strips to determine the next dropped symbols or generate each dropped symbol randomly.

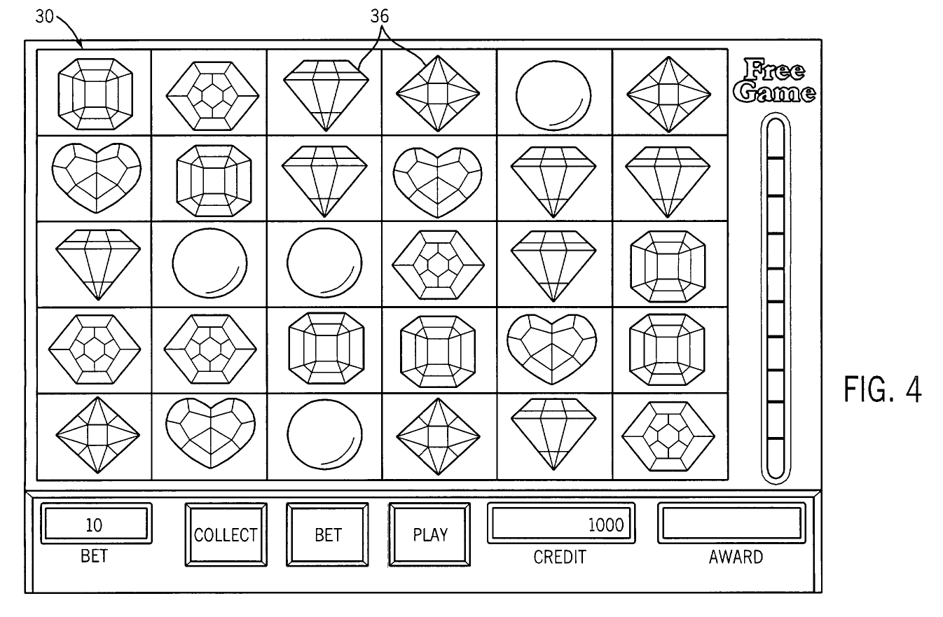

Referring to FIG. 4, after the symbols 36 are dropped into the empty array 30, the array 30 is filled with symbols at respective positions. An object of the first embodiment of the wagering game is for the player to select any pairs of vertically or horizontally adjacent symbols in the symbol array 30 that, when swapped (exchanged), create a predefined, award-generating symbol combination. The award-generating symbol combination preferably includes at least three matching symbols that are adjacent to each other and aligned along a row or column of the array 30. The machine provides an award associated with the created symbol combination. The greater the number of matching symbols in the symbol combination, the greater the award. Also, it is possible for a single swap to create multiple winning symbol matches. In the illustrated example, the initial drop of symbols 36 into the empty array 30 produced no winning matches of at least three symbols.

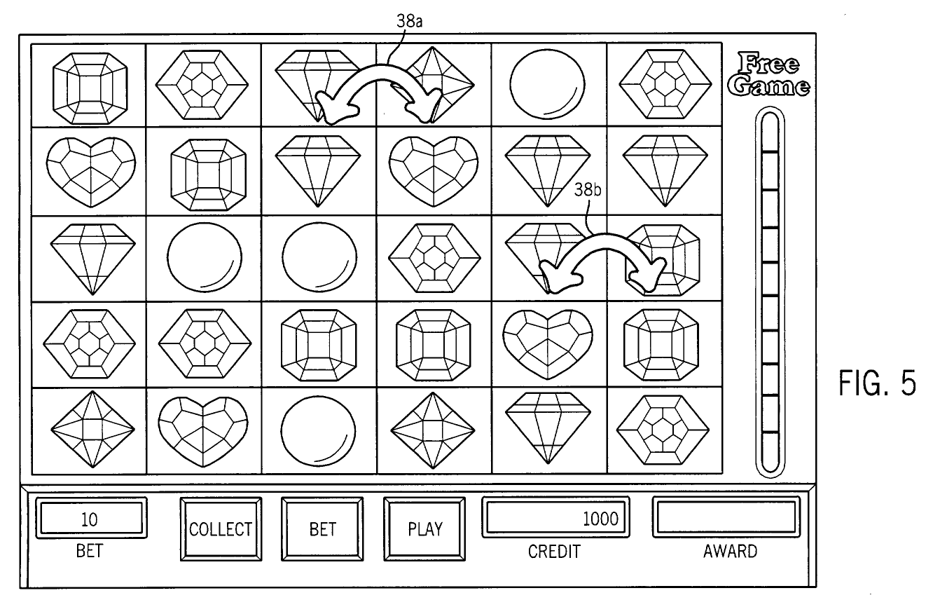

Referring to FIG. 5, although the initial drop produced no winning symbol matches, the display depicts arrows 38a and 38b indicating possible pairs of adjacent symbols that may be swapped to yield symbol matches. In the illustrated example, the player selects the arrow 38a (e.g., by touching the arrow 38a) to swap the heart symbol and the diamond symbol.

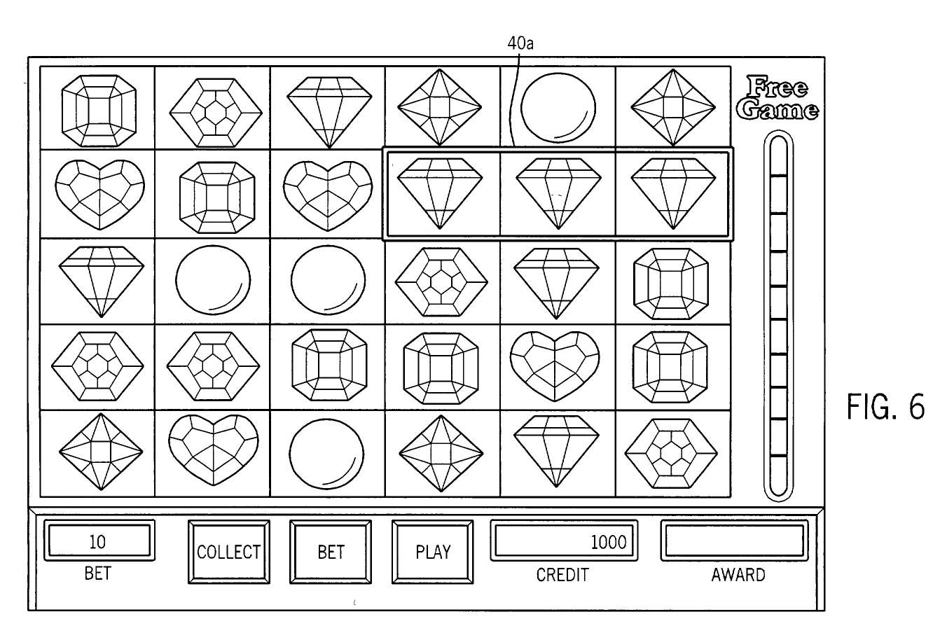

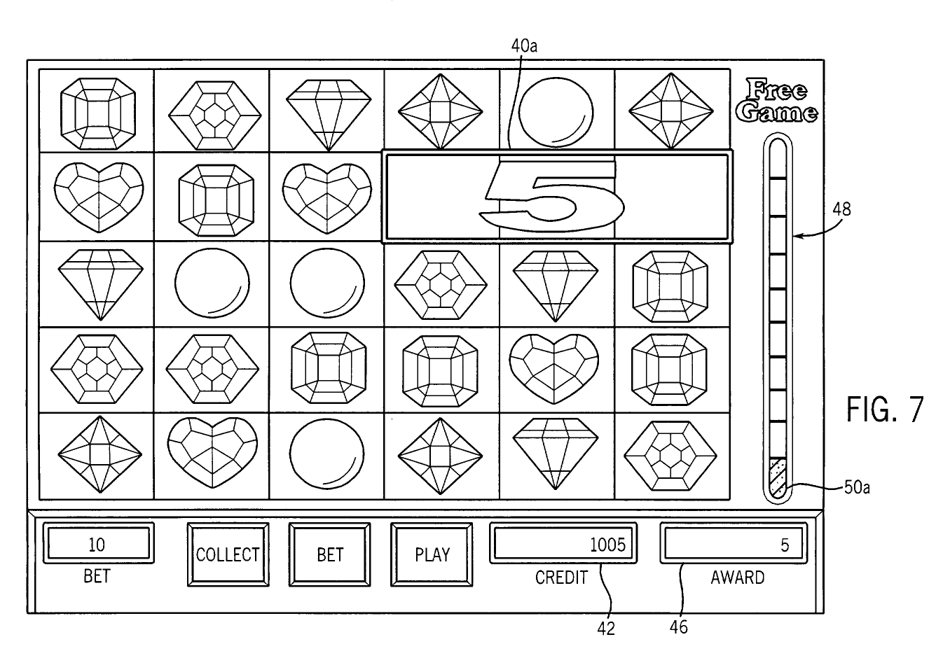

Referring to FIG. 6, the swapped symbols yield a highlighted winning match 40a of three diamond symbols. Referring to FIG. 7, the winning match 40a is replaced with the number “5” to indicate that the match is associated with an award of 5 credits. The award is shown on an award meter 46 and added to the credit meter 42. The winning match also highlights a level or segment 50a of a free game meter 48. During a current play cycle, each winning match highlights another segment of the free game meter 48. In the illustrated example, the free game meter 48 includes ten segments. If all of the segments are highlighted, the player is awarded a free play cycle. The free game meter 48 resets to no highlighted segments prior to each play cycle. A “play cycle” is initiated by a wager, except when the player is awarded a free play cycle by filling the free game meter 48.

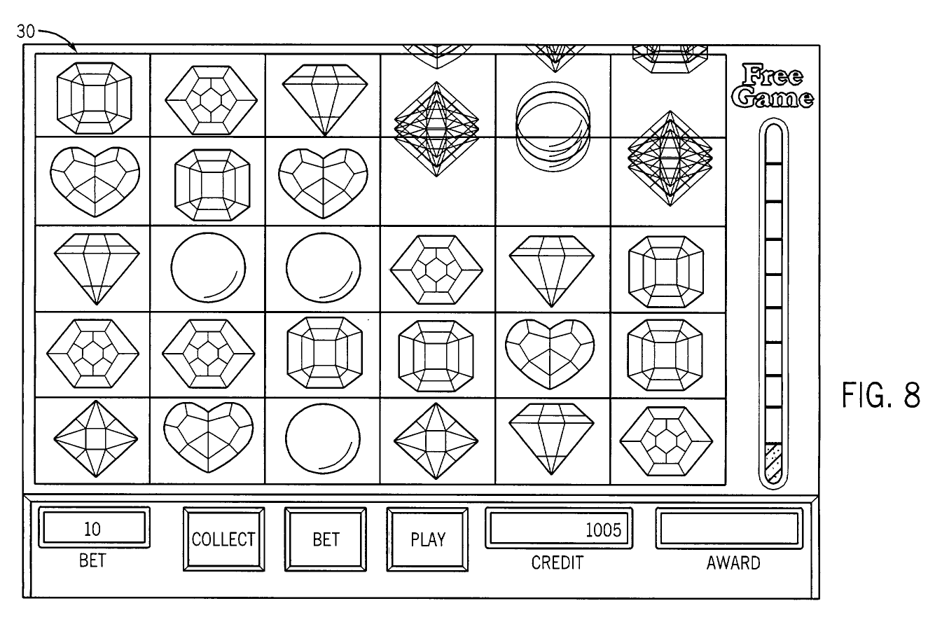

Referring to FIG. 8, the winning match and award disappear and symbols that were above the match shift/cascade downward to fill the positions vacated by the symbols in the match. Also, to the extent the cascading symbols leave any empty positions at the top of the array 30, the empty positions are filled with new randomly selected symbols that drop into the array 30.

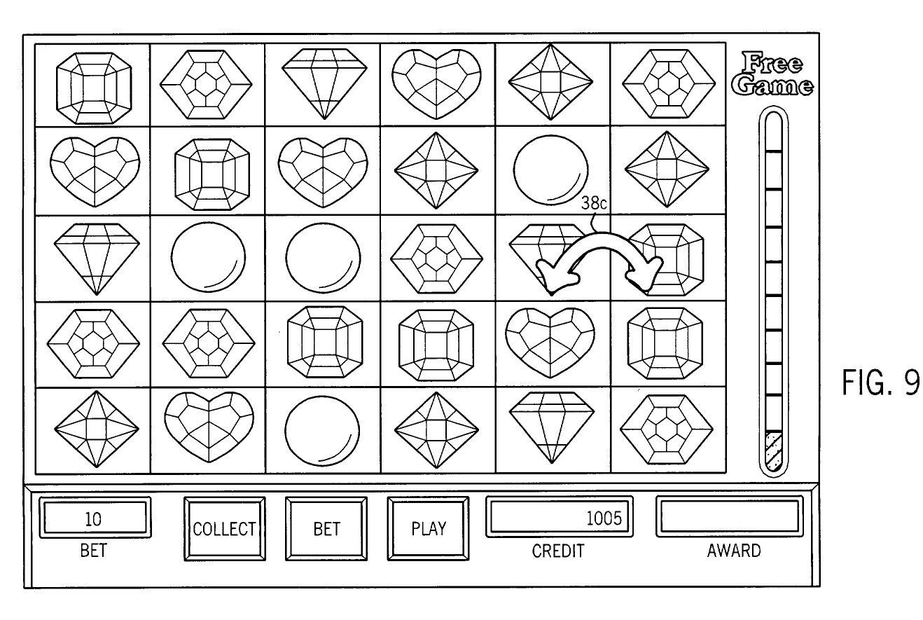

Referring to FIG. 9, the above process of swapping adjacent symbols to create winning symbol matches and earn associated awards is repeated until either a free game is awarded or no more matches can be created by swapping any pair of adjacent symbols (i.e., the player has won all of the possible matches). In FIG. 9, for example, the display depicts an arrow 38c indicating a pair of adjacent symbols that may be swapped to yield a winning symbol match. The player selects the arrow 38c (e.g., by touching the arrow 38c) to swap the heart symbol and the emerald symbol.

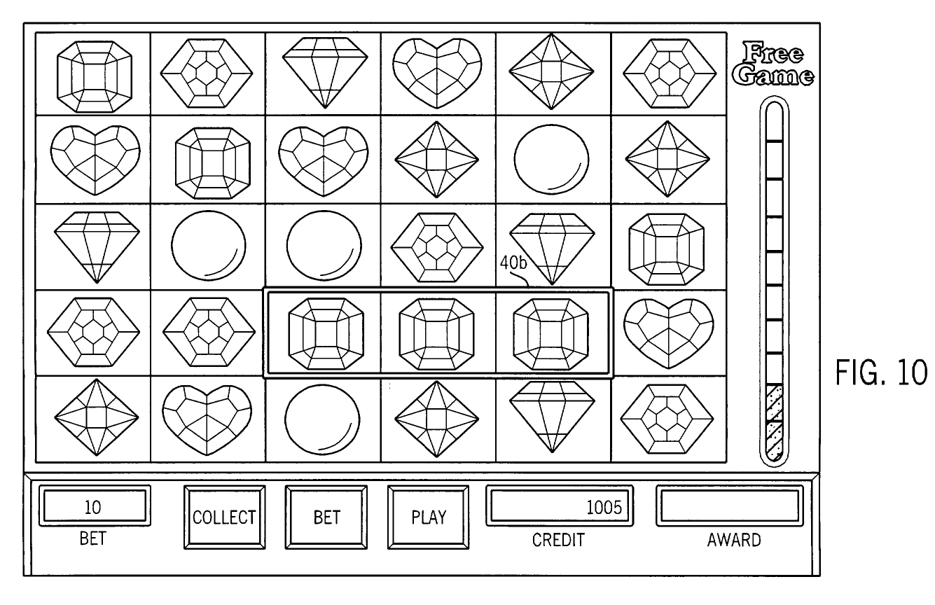

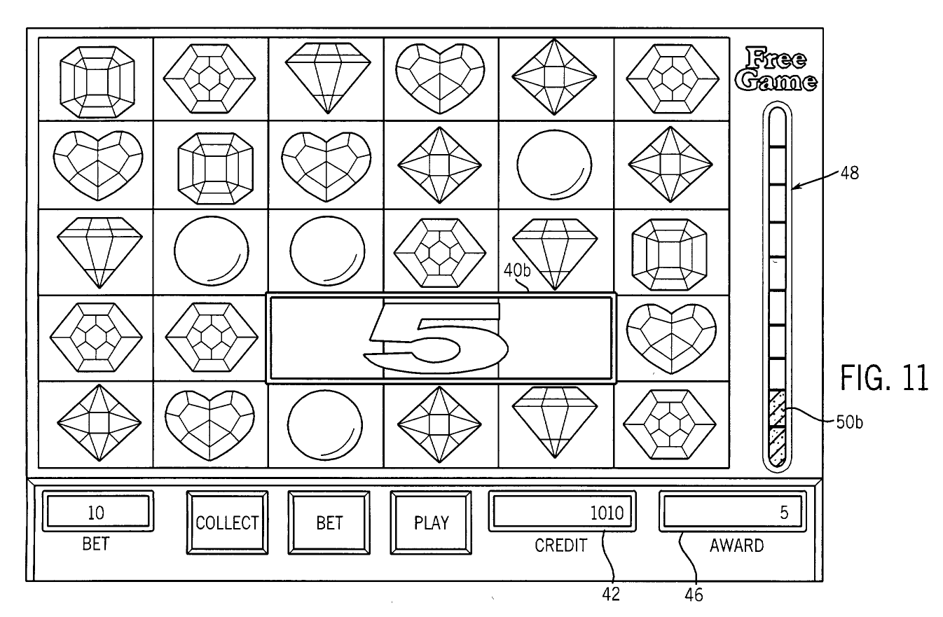

Referring to FIG. 10, the swapped symbols yield a highlighted winning match 40b of three emerald symbols. Referring to FIG. 11, the winning match 40b is replaced with the number “5” to indicate that the match is associated with an award of 5 credits. The award is shown on the award meter 46 and added to the credit meter 42. The winning match also highlights another segment 50b of the free game meter 48.

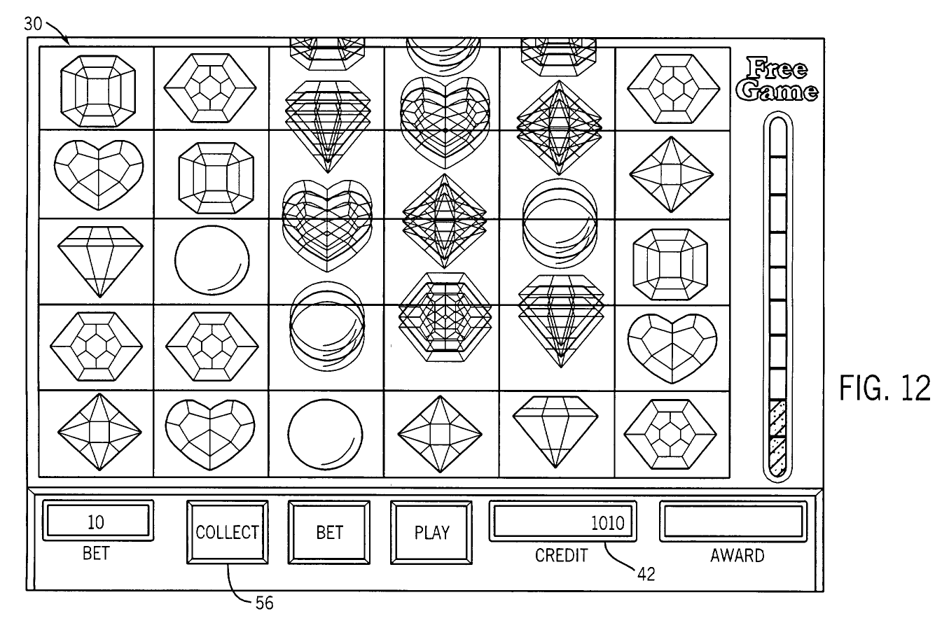

Referring to FIG. 12, the winning match and award disappear and symbols that were above the match shift/cascade downward to fill the positions vacated by the symbols in the match. Also, to the extent the cascading symbols leave any empty positions at the top of the array 30, the empty positions are filled with new randomly selected symbols that drop into the array 30.

As noted above, the swapping process is repeated until either a free game is awarded or no more matches can be created by swapping any pair of adjacent symbols. At that point, the player may place a wager to initiate a new play cycle. When the player no longer wishes to play the symbol matching gaming machine, the player may collect any credits remaining on the credit meter 42 by pressing an onscreen or physical “Collect” key 56.

In the first embodiment, the minimum and maximum wager amounts and award amounts are merely given by way of example. Other amounts are possible so long as such amounts yield practical hold percentages when considered in conjunction with the probabilities of achieving winning symbol matches during each play cycle of the game.

In an alternative to the first embodiment, instead of requiring the symbols in a winning match to be identical to each other, winning matches may be defined to include symbols that are different but associated in a pre-defined manner. If the symbols are traditional slot symbols, for example, a match may include a single bar, a double bar, and a triple bar, or may include a red 7, a white 7, and a blue 7. Furthermore, instead of requiring the symbols in a winning match to be aligned along a row or a column of the array 30, other winning patterns may be defined. Examples of other possible winning patterns include matching symbols along a diagonal, in an L shape, in a T shape, or in the four corners of the array 30. Similarly, instead of requiring the swapped symbols to be vertically or horizontally adjacent to each other, the swapped symbols may have some other predefined relationship (e.g., diagonally adjacent) relative to each other.

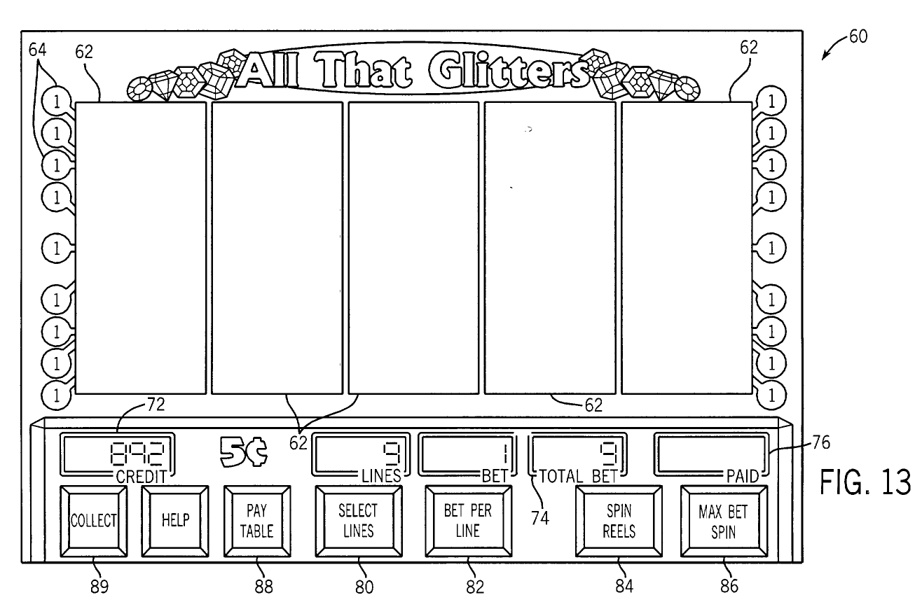

FIGS. 13 through 20 are display screen images associated with a second embodiment of the present invention. This embodiment has a traditional flavor in that the symbol array is defined by a reel-like display of a video slot game and has a plurality of pay lines extending through the positions of the array. Referring to FIG. 13, the display initially portrays an empty array 60 including a plurality of a plurality of reel-like columns 62. Each of a plurality of pay lines 64 extend through at least one symbol position on each of the columns 62. To begin play, a player inserts money into the gaming machine. The amount of inserted money is shown as a corresponding number of credits on a credit meter 72. Next, to initiate a play cycle, the player selects the number of pay lines (e.g., between one and nine) to play by pressing a “Select Lines” key 80 on the video display. The player then chooses the number of coins or credits to bet on the selected pay lines by pressing the “Bet Per Line” key 82 a number of times corresponding to the desired number of wagered credits. The total number of wagered credits is shown on a total bet meter 74. After activation of the pay lines, a symbol drop may be initiated by touching the “Spin Reels” key 84 or, if the player wishes to bet the maximum amount per line, by using the “Max Bet Spin” key 86 on the video display.

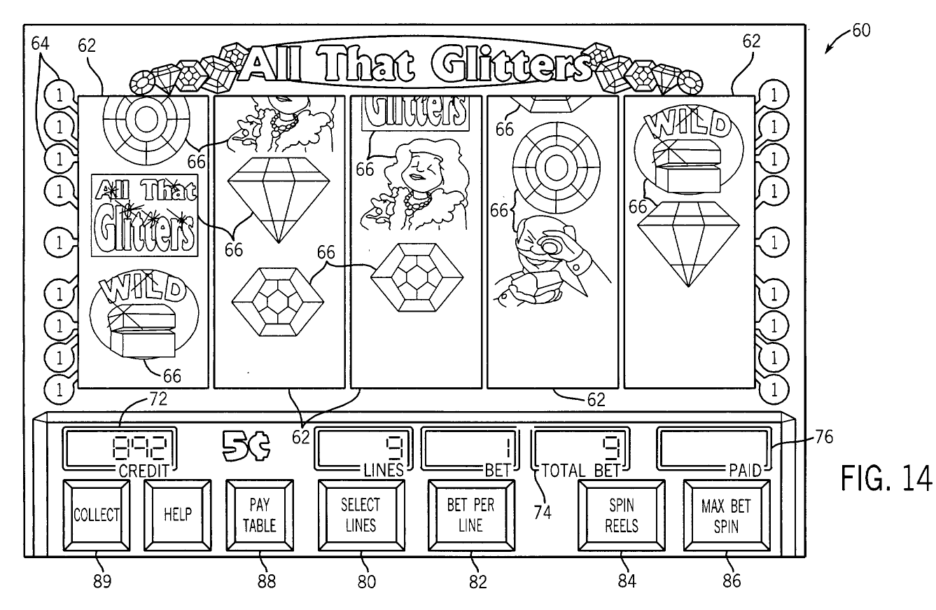

Referring to FIG. 14, in response to initiating a symbol drop, symbols 66 drop into the empty array 60 from the top of the display. The symbols 66 may, for example, include gems, traditional slot symbols such as fruits, sevens, and bars, or other thematic symbols. The machine randomly selects the dropped symbols 66 using a random number generator (RNG). After the symbols 66 are dropped into the empty array 60, the array 60 is filled with symbols at respective positions.

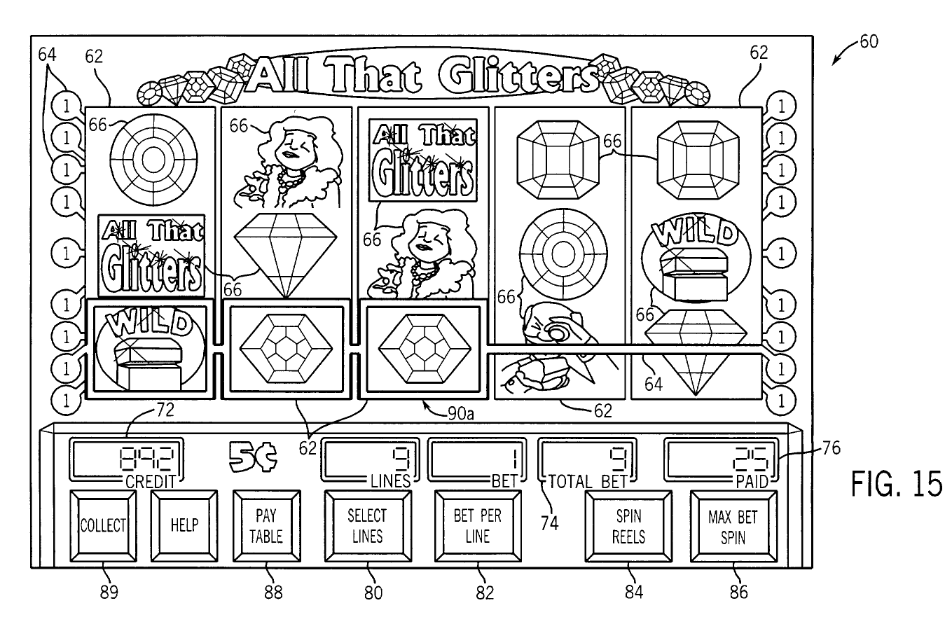

Referring to FIG. 15, the machine evaluates the filled array 60 for predefined, winning combinations of symbols along any of the pay lines 64. Winning combinations (e.g., symbol combinations resulting in payment of coins or credits) are identifiable to the player by a pay table. In one embodiment, the pay table is affixed to the machine and/or displayed by the video display in response to a command by the player (e.g., by pressing a “Pay Table” key 88). A winning combination occurs when the symbols appearing in the array 60 along an active pay line correspond to one of the winning combinations on the pay table. A winning combination, for example, could be two or more matching symbols along an active pay line, where the award is greater as the number of matching symbols along the active pay line increases. If the dropped symbols land in a winning combination, the game credits the player an amount corresponding to the award in the pay table for that combination multiplied by the amount of credits bet on the winning pay line. In one implementation, the winning combinations start from the leftmost one of the columns 62 and span adjacent columns. In an alternative implementation, the winning combinations start from either the leftmost one of the columns 62 or the rightmost one of the columns 62 and span adjacent columns 62. Each winning combination is preferably highlighted on the video display. In the illustrated example, the initial drop of symbols 66 into the empty array 60 produced a winning combination 90a of a wild symbol and a pair of matching gems along one of the pay lines 64. The machine provides an award (e.g., 25 credits) associated with that winning combination 90a. The award is added to a paid meter 76.

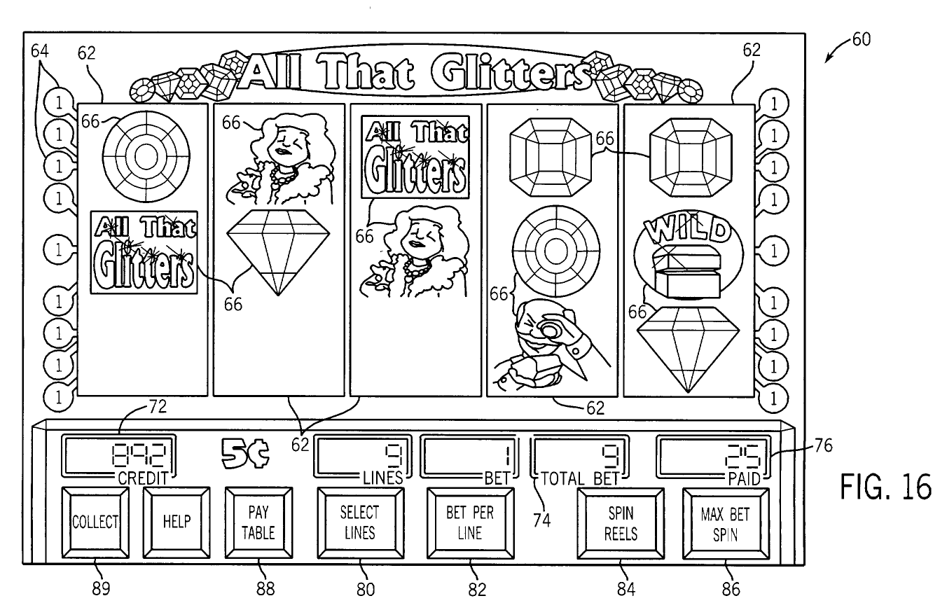

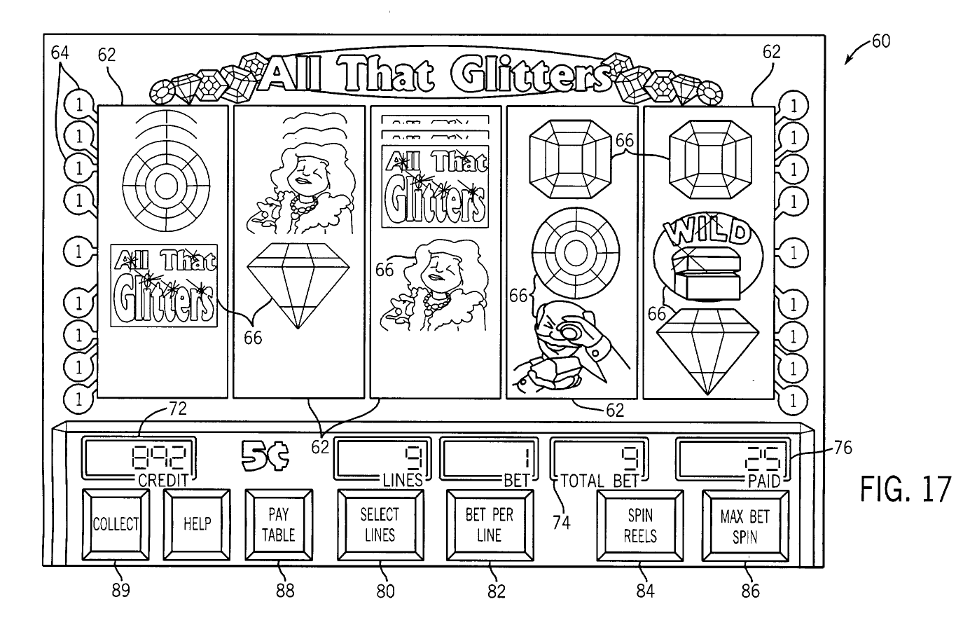

Referring to FIG. 16, the winning combination 90a in FIG. 15 disappears. If the array 60 had contained multiple winning combinations, all of the winning combinations would disappear. Referring to FIG. 17, symbols that were above the winning combination shift/cascade downward to fill the positions vacated by the symbols in the winning combination. Also, to the extent the cascading symbols leave any empty positions at the top of the array 60, the empty positions are filled with new randomly selected symbols that drop into the array 60.

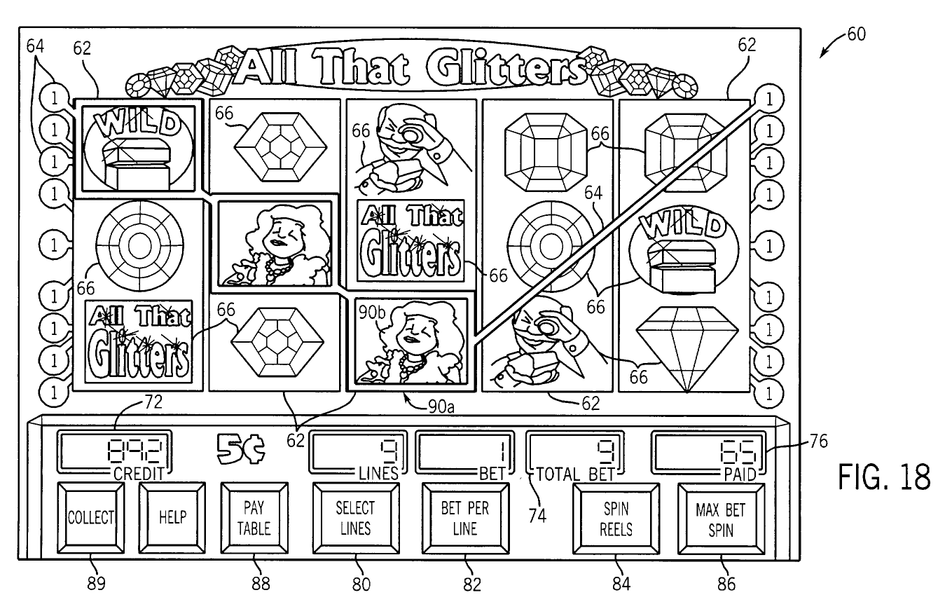

FIG. 18 depicts the re-filled array 60. The machine evaluates the re-filled array 60 for predefined, winning combinations of symbols along any of the pay lines 64. In the illustrated example, the re-filled array 60 contains a winning combination 90b of a wild symbol and a pair of matching character symbols along one of the pay lines 64. The machine provides an award (e.g., 40 credits) associated with that winning combination 90b. The award is added to the paid meter 76.

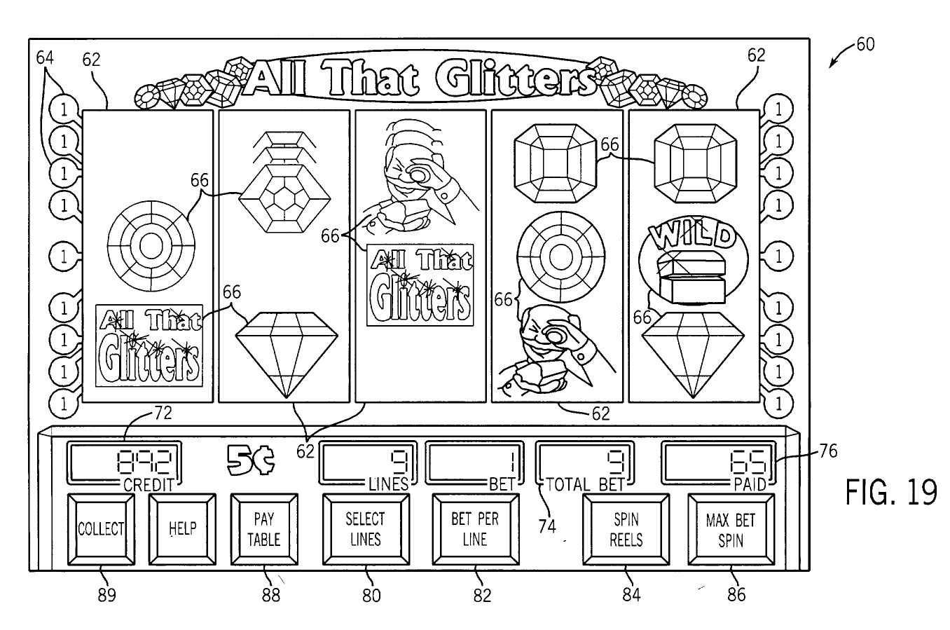

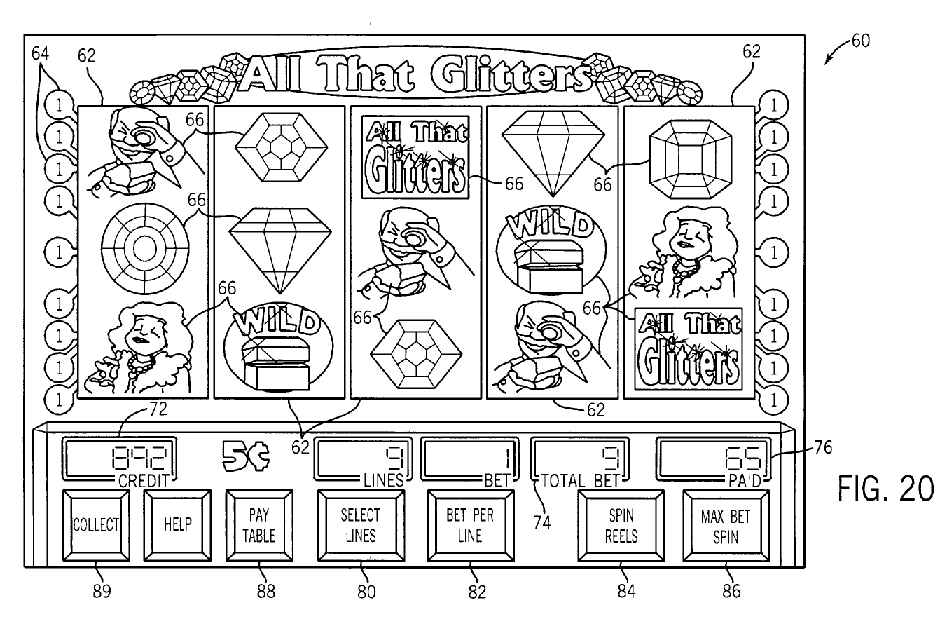

Referring to FIG. 19, the above process of replacing the symbols in the winning combination with cascading symbols and evaluating the re-filled array 60 for winning symbol combinations is repeated until no more winning combinations are formed. FIG. 20 depicts the array 60 when no more winning combinations are formed. At that point, the player may place a wager to initiate a new play cycle. When the player no longer wishes to play the symbol matching gaming machine, the player may collect any credits remaining on the credit meter 72 by pressing a “Collect” key 89.

While the present invention has been described with reference to one or more particular embodiments, those skilled in the art will recognize that many changes may be made thereto without departing from the spirit and scope of the present invention.

For example, the interactive symbol swap feature of the first embodiment (FIGS. 3 through 12) may be added to the second embodiment (FIGS. 13 through 20). Also, in both embodiments, certain game outcomes may trigger a bonus game similar to or different from the symbol matching game. Following completion of the bonus game, the CPU shifts operation back to the symbol matching game. Further, instead of cascading symbols downward to fill empty positions in the symbol array, the symbols may merely “pop” into an empty array position or may enter the symbol array in a different direction, such as upward or sideways.

Each of these embodiments and obvious variations thereof is contemplated as falling within the spirit and scope of the claimed invention, which is set forth in the following claims:

What is claimed is:

1. A method of conducting a wagering game on a gaming machine, comprising:
receiving a wager from a player;
portraying an array of symbols at respective positions in the array;
receiving input from the player specifying at least one of the symbols in the array and a target position in the array for the specified symbol; and
moving the specified symbol from its original position to the target position to create a predefined, award-generating symbol combination, the symbol combination including the specified symbol; and
providing an award associated with the symbol combination.

2. The method of claim 1, further including placing a substitute symbol in the original position vacated by the specified symbol.

3. The method of claim 2, wherein the substitute symbol is the symbol that was in the target position prior to the moving step so that the specified symbol and the substitute symbol are swapped.

4. The method of claim 1, wherein the award-generating symbol combination includes a plurality of associated symbols.

5. The method of claim 4, wherein the plurality of associated symbols are adjacent to each other and aligned along a row or column of the array.

6. The method of claim 4, wherein the plurality of associated symbols are substantially identical to each other.

7. The method of claim 4, further including replacing the associated symbols in the plurality of associated symbols with respective replacement symbols.

8. The method of claim 7, further including determining, after the replacing step, whether or not the array includes any other predefined award-generating symbol combinations.

9. The method of claim 8, further including providing an award associated with each of the other symbol combinations.

10. The method of claim 9, wherein each of the other symbol combinations includes a plurality of related symbols, and further including replacing the related symbols in the plurality of related symbols with respective replacement symbols.

11. The method of claim 7, wherein the replacement symbols are a group of symbols in the array that, prior to the replacing step, was adjacent to the plurality of associated symbols.

12. The method of claim 11, wherein the plurality of associated symbols occupy one or more columns of the array, and wherein the replacing step includes shifting symbols in the one or more columns downward to fill the positions occupied by the plurality of associated symbols prior to the replacing step.

13. The method of claim 1, further including repeating the receiving, moving, and providing steps until a predefined, award-generating symbol combination cannot be created by the moving step.

14. The method of claim 1, further including indicating to the player, prior to the receiving step, which of the symbols in the array may be specified and moved to create a predefined, award-generating symbol combination.

15. A method of conducting a wagering game on a gaming machine, comprising:
receiving a wager from a player;
portraying an array of symbols at respective positions in the array;
indicating to the player any pairs of symbols in the array that may be swapped to create a predefined, award-generating symbol combinations;
receiving a selection from the player of one of the any pairs of symbols to swap;
swapping the selected pair of symbols; and
providing an award associated with the symbol combination.

16. The method of claim 15, further including repeating the indicating, receiving, swapping, and providing steps until a predefined, award-generating symbol combination cannot be created by the swapping step.

17. The method of claim 15, further including removing the symbols in the symbol combination from the array, shifting symbols that were above the symbol combination downward to fill the positions vacated by the symbols in the symbol combination, and placing new symbols in any remaining empty positions in the array.

18. A gaming machine comprising:
means for receiving a wager from a player;
means for portraying an array of symbols at respective positions in the array;
means for receiving input from the player specifying at least one of the symbols in the array and a target position in the array for the specified symbol; and
means for moving the specified symbol from its original position to the target position to create a predefined, award-generating symbol combination, the symbol combination including the specified symbol; and
means for providing an award associated with the symbol combination.

19. The machine of claim 18, further including means for placing a substitute symbol in the original position vacated by the specified symbol.

20. The machine of claim 19, wherein the substitute symbol is the symbol that was in the target position prior to moving the specified symbol so that the specified symbol and the substitute symbol are swapped.

21. The machine of claim 18, wherein the award-generating symbol combination includes a plurality of associated symbols.

22. The machine of claim 21, wherein the plurality of associated symbols are adjacent to each other and aligned along a row or column of the array.

23. The machine of claim 21, wherein the plurality of associated symbols are substantially identical to each other.

24. The machine of claim 21, further including means for replacing the associated symbols in the plurality of associated symbols with respective replacement symbols.

25. The machine of claim 24, further including means, responsive to the replacing means, for determining whether or not the array includes any other predefined award-generating symbol combinations.

26. The machine of claim 25, further including means for providing an award associated with each of the other symbol combinations.

27. The machine of claim 26, wherein each of the other symbol combinations includes a plurality of related symbols, and further including means for replacing the related symbols in the plurality of related symbols with respective replacement symbols.

28. The machine of claim 24, wherein the replacement symbols are a group of symbols in the array that, prior to replacing the associated symbols, was adjacent to the plurality of associated symbols.

29. The machine of claim 28, wherein the plurality of associated symbols occupy one or more columns of the array, and wherein the replacing means shifts symbols in the one or more columns downward to fill the positions occupied by the plurality of associated symbols prior to replacing the associated symbols.

30. The machine of claim 18, wherein the receiving means, the moving means, and the providing means operate repetitively until a predefined, award-generating symbol combination cannot be created by the moving means.

31. The machine of claim 18, further including means for indicating to the player which of the symbols in the array may be specified and moved to create a predefined, award-generating symbol combination.

32. A gaming machine comprising:
means for receiving a wager from a player;
means for portraying an array of symbols at respective positions in the array;
means for indicating to the player any pairs of symbols in the array that may be swapped to create a predefined, award-generating symbol combinations;
means for receiving a selection from the player of one of the any pairs of symbols to swap;
means for swapping the selected pair of symbols; and
means for providing an award associated with the symbol combination.

33. The machine of claim 32, wherein the indicating means, the receiving means, the swapping means, and the providing means operate repetitively until a predefined, award-generating symbol combination cannot be created by the swapping means.

34. The machine of claim 32, further including means for removing the symbols in the symbol combination from the array, shifting symbols that were above the symbol combination downward to fill the positions vacated by the symbols in the symbol combination, and placing new symbols in any remaining empty positions in the array.

35. A method of conducting a wagering game on a gaming machine, comprising:
receiving a wager from a player;
portraying an array of symbols at respective positions in the array;
evaluating the array for any predefined, winning symbol combinations;
if the array contains one of the winning symbol combinations, providing an award associated with that winning combination; and
replacing the symbols in the winning combination with respective replacement symbols.

36. The method of claim 35, wherein each of the winning symbol combinations includes a plurality of associated symbols.

37. The method of claim 36, wherein the plurality of associated symbols are adjacent to each other and aligned along a predefined pay line, the predefined pay line extending through a plurality of positions in the array.

38. The method of claim 35, further including re-evaluating, after the replacing step, the array for any of the predefined, winning symbol combinations.

39. The method of claim 38, further including repeating the providing, replacing, and re-evaluating steps until the array does not contain any of the winning symbol combinations.

40. The method of claim 35, wherein the replacement symbols are a group of symbols in the array that, prior to the replacing step, was adjacent to the winning symbol combination.

41. The method of claim 40, wherein the replacing step includes shifting symbols in the array to fill positions of the array occupied by the winning combination prior to the replacing step.

42. The method of claim 41, further including filling any empty positions left in the array by the shifted symbols with new randomly selected symbols.

43. The method of claim 35, wherein the replacing step includes shifting symbols in the array to fill positions of the array occupied by the winning combination prior to the replacing step, and further including filling any empty positions left in the array by the shifted symbols with new randomly selected symbols.
